(19) United States
(12) Patent Application Publication
(10) Pub. No.: US 2013/0314413 A1
(43) Pub. Date: Nov. 28, 2013

(54) SYSTEMS AND METHODS FOR SCALING A THREE-DIMENSIONAL MODEL

(71) Applicant: 1-800 CONTACTS, INC., Draper, UT (US)

(72) Inventors: Jonathan Coon, Austin, TX (US); Ryan Engle, Pflugerville, TX (US)

(73) Assignee: 1-800 CONTACTS, INC., Draper, UT (US)

(21) Appl. No.: 13/774,995

(22) Filed: Feb. 22, 2013

Related U.S. Application Data
(63) Continuation-in-part of application No. 13/706,909, filed on Dec. 6, 2012.
(60) Provisional application No. 61/650,983, filed on May 23, 2012.
(60) Provisional application No. 61/735,951, filed on Dec. 11, 2012.

(51) Int. Cl. G06T 17/00

(52) U.S. Cl. CPC G06T 17/00
USPC 345/420

(57) ABSTRACT

An image that includes a depiction of a scale marker and a depiction of an object is obtained. The scale marker has a predetermined size. A 3D model of the object is mapped to a 3D space based on the depiction of the object. A 3D model of the scale marker is mapped to the 3D space based on the depiction of the scale marker. The 3D model of the scale marker has the predetermined size. A point of intersection between the 3D model of the scale marker and the 3D model of the object is determined. The 3D model of the object is scaled based on the predetermined size of the 3D model of the scale marker.

### RELATED APPLICATIONS

This application is a continuation-in-part of U.S. application Ser. No. 13/706,909, entitled SYSTEMS AND METHODS FOR OBTAINING A PUPILLARY DISTANCE MEASUREMENT USING A MOBILE COMPUTING DEVICE, filed on Dec. 6, 2012; and also claims priority to U.S. Application No. 61/650,983, entitled SYSTEMS AND METHODS TO VIRTUALLY TRY-ON PRODUCTS, filed on May 23, 2012; and U.S. Application No. 61/735,951, entitled SYSTEMS AND METHODS TO VIRTUALLY TRY-ON PRODUCTS, filed on Jan. 2, 2013, all of which are incorporated herein in their entirety by this reference.

### BACKGROUND

The use of computer systems and computer-related technologies continues to increase at a rapid pace. This increased use of computer systems has influenced the advances made to computer-related technologies. Indeed, computer devices have increasingly become an integral part of the business world and the activities of individual consumers. Computing devices may be used to carry out several business, industry, and academic endeavors.

In various situations, three-dimensional (3D) models may be used to provide increased functionality and/or enhance the user experience. In some cases, multiple 3D models may be associated together. For example, multiple 3D models may be associated together to generate a virtual try-on (e.g., a virtual glasses, try-on, for example). However, associating multiple 3D models together that aren't scaled based on the same standard may result in inaccurate representations.

### SUMMARY

According to at least one embodiment, a computer-implemented method for scaling a three-dimensional (3D) model. An image that includes a depiction of a scale marker and a depiction of an object is obtained. The scale marker has a predetermined or ascertainable size. A 3D model of the object is mapped to a 3D space based on the depiction of the object. A 3D model of the scale marker is mapped to the 3D space based on the depiction of the scale marker. The 3D model of the scale marker has the predetermined or ascertained size. A point of intersection between the 3D model of the scale marker and the 3D model of the object is determined. The 3D model of the object is scaled based on the predetermined or ascertained size of the 3D model of the scale marker.

In some cases, the 3D model of the object and/or the 3D model of the scale marker may be adjusted in the 3D space to obtain the point of intersection. In one embodiment, the 3D model of the object is a morphable model.

In some embodiments, a first relationship may be determined based on the depiction of the object and the depiction of the scale marker. The first relationship may be between the object and the scale marker. In one example, the first relationship is an orientation relationship between a determined orientation of the object and a determined orientation of the scale marker. In another example, the first relationship is a position relationship between a position of the object and a position of the scale marker. In yet another example, the first relationship is a size relationship between a size of the object and a size of the scale marker.

In some cases, mapping the 3D model of the object to the 3D space includes adjusting the 3D model of the object to obtain a second relationship that is the same as the first relationship. In some cases mapping the 3D model of the scale marker to the 3D space includes adjusting the 3D model of the scale marker to obtain a second relationship that is the same as the first relationship. The second relationship may be between the 3D model of the object and the 3D model of the scale marker.

A computing device configured to scale a three-dimensional (3D) model is also described. The device may include a processor and memory in electronic communication with the processor. The memory may store instructions that are executable by the processor to obtain an image that includes a depiction of a scale marker and a depiction of an object, map a 3D model of the object to a 3D space based on the depiction of the object, map a 3D model of the scale marker to the 3D space based on the depiction of the scale marker, determine a point of intersection between the 3D model of the scale marker and the 3D model of the object, and scale the 3D model of the object based on the predetermined or ascertainable size of the 3D model of the scale marker. The scale marker has a predetermined or ascertainable size. The 3D model of the scale marker has the predetermined or ascertainable size.

A computer-program product to scale a three-dimensional (3D) model is also described. The computer-program product may include a non-transitory computer-readable medium that stores instructions. The instructions may be executable by a processor to obtain an image that includes a depiction of a scale marker and a depiction of an object, map a 3D model of the object to a 3D space based on the depiction of the object, map a 3D model of the scale marker to the 3D space based on the depiction of the scale marker, determine a point of intersection between the 3D model of the scale marker and the 3D model of the object, and scale the 3D model of the object based on the predetermined or ascertainable size of the 3D model of the scale marker. The scale marker has a predetermined or ascertainable size. The 3D model of the scale marker has the predetermined or ascertainable size.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram illustrating one embodiment of an environment in which the present systems and methods may be implemented;

FIG. 2 is a block diagram illustrating another embodiment of an environment in which the present systems and methods may be implemented;

FIG. 3 is a block diagram illustrating one example of a scaling module;

FIG. 4 is a block diagram illustrating one example of a mapping module;

FIG. 5 is a diagram illustrating one example of an object and a scale marker that may be captured in an image for use in the systems and methods described herein;

FIG. 6 is a diagram illustrating an example of a device for capturing an image of the user holding the credit card;

FIG. 7 illustrates an example arrangement for capturing an image that includes a depiction of a scale marker and a depiction of an object;

FIG. 8 illustrates another example arrangement for capturing an image that includes a depiction of a scale marker and a depiction of an object;

FIG. 9 is a diagram illustrating one example of an operation of the scaling module to map a 3D model of a user and a 3D model of a scale marker into the same 3D space;

FIG. 10 is a diagram illustrating one example of an operation of the scaling module to determine a point of intersection between the 3D model of the user and the 3D model of the scale marker;

FIG. 11 is a flow diagram illustrating one example of a method to scale a 3D model;

FIG. 12 is a flow diagram illustrating another example of a method to scale a 3D model; and

FIG. 13 depicts a block diagram of a computer system suitable for implementing the present systems and methods.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

In various situations, it may be desirable to scale a three-dimensional (3D) model. For example, it may be desirable to scale a 3D model so that two or more 3D models may be scaled according to a common (e.g., a single) scaling standard. In some embodiments, the systems and methods described herein may scale a 3D model according to a specific scaling standard. In some cases, scaling two or more 3D models according to a common scaling standard may allow the 3D models to be associated together with proper scaling. For instance, the systems and methods described herein may allow for proper scaling of 3D models when virtually tying-on products (e.g., virtually trying-on a pair of glasses). Although many of the examples used herein describe the scaling of a morphable model, it is understood that the systems and methods described herein may be used to scale any model of an object.

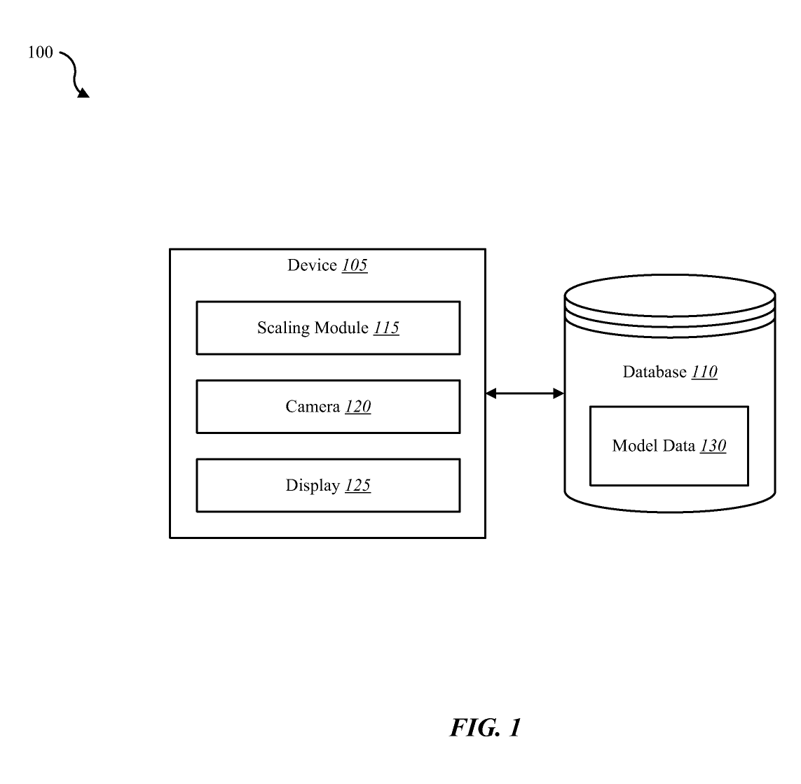

FIG. 1 is a block diagram illustrating one embodiment of an environment 100 in which the present systems and methods may be implemented. In some embodiments, the systems and methods described herein may be performed on a single device (e.g., device 105). For example, the systems and method described herein may be performed by a scaling module 115 that is located on the device 105. Examples of device 105 include mobile devices, smart phones, personal computing devices, computers, servers, etc.

In some configurations, a device 105 may include the scaling module 115, a camera 120, and a display 125. In one example, the device 105 may be coupled to a database 110. In one embodiment, the database 110 may be internal to the device 105. In another embodiment, the database 110 may be external to the device 105. In some configurations, the database 110 may include model data 130.

In one embodiment, the scaling module 115 may scale a 3D model of an object. In one example, scaling a 3D model of an object enables a user to view an image on the display 125 that is based on the scaled, 3D model of the object. For instance, the image may depict a user virtually trying-on a pair of glasses with both the user and the glasses being scaled according to a common scaling standard.

In some configurations, the scaling module 115 may obtain an image that depicts an object and a scale marker that is touching the object (in at least one point of contact, for example). For instance, the image may depict a user that is holding a scale marker in a manner that the scale marker is touching the user. The scale marker may be an (any) object of known size. In one example, the scale marker may be a credit card. In another example, the scale marker may be a mobile device.

In one example, the user may hold a credit card in contact with a portion of the user (e.g., the forehead). The camera 120 may capture an image of the user holding the credit card in contact with his/her forehead. In one embodiment, the scaling module may obtain a 3D representation (e.g., model) of the user and a 3D model of the credit card. In one example, the 3D representation of the user may be a morphable model of the user. The 3D model of the credit card may have a known (e.g., predetermined) size (according to a particular measuring standard, for example). In some configurations, the scaling module 115 may scale the 3D representation of the user based on the image of the user holding the scale marker. For example, the scaling module 115 may determine a relationship between the size of the user in relation to the size of the scale marker based on the image of the user holding the scale marker. In one example, the scaling module 115 may use the determined relationship between the user and the scale marker in the image of the user holding the scale marker to scale the 3D representation of the user based on the known size of the 3D model of the credit card.

In one embodiment, the 3D model of an object may be obtained based on the model data 130. In one example, the model data 130 may be based on an average model that may be adjusted according to measurement information determined about the object (e.g., a morphable model approach). In one example, the 3D model of the object may be a linear combination of the average model. In some embodiments, the model data 130 may include one or more definitions of color (e.g., pixel information) for the 3D model of the object (e.g., user). In one example, the 3D model of the object may have an arbitrary size. In some embodiments, the scaled 3D model of the object (as scaled by the systems and methods described herein, for example) may be stored in the model data 130. In some cases, the model data 130 may include the image of the user holding the scale marker.

In some cases, an image based on the scaled 3D model of an object may be displayed via the display 125. For example, an image of a virtual try-on based on the scaled 3D representation of a user and a 3D model of glasses scaled according to a common scaling standard may be displayed to the user via the display 125.

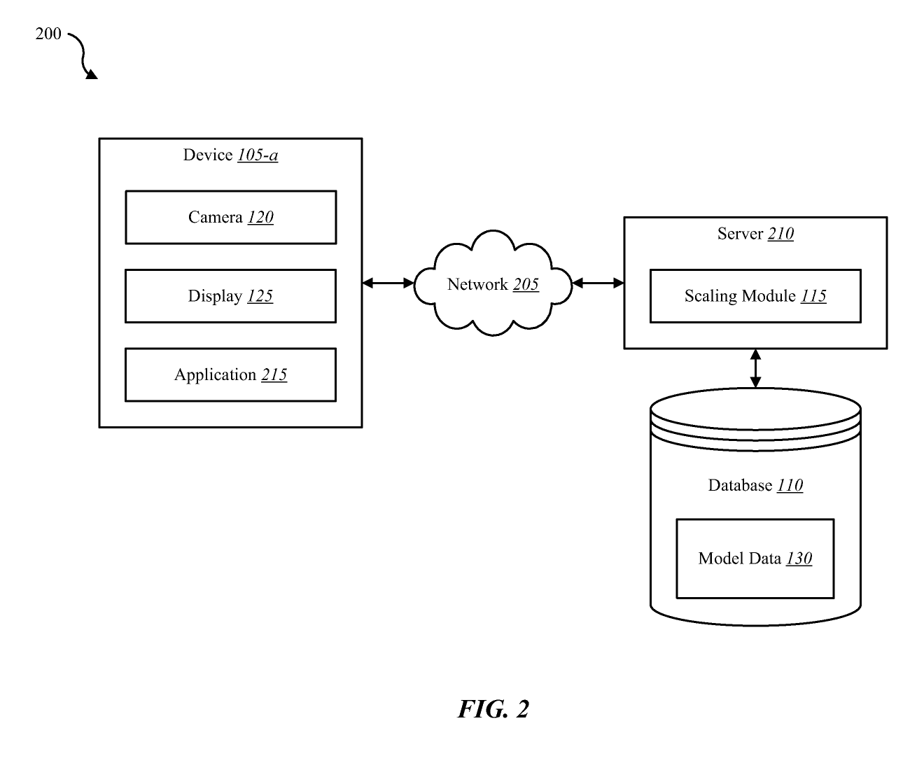

FIG. 2 is a block diagram illustrating another embodiment of an environment 200 in which the present systems and methods may be implemented. In some embodiments, a device 105-a may communicate with a server 210 via a network 205. Examples of networks 205 include local area networks (LAN), wide area networks (WAN), virtual private networks (VPN), cellular networks (using 3G and/or LTE, for example), etc. In some configurations, the network 205 may be the internet. In some configurations, the device 105-a may be one example of the device 105 illustrated in FIG. 1. For example, the device 105-a may include the camera 120, the display 125, and an application 215. It is noted that in some embodiments, the device 105-a may not include a scaling module 115.

In some embodiments, the server 210 may include the scaling module 115. In one embodiment, the server 210 may be coupled to the database 110. For example, the scaling module 115 may access the model data 130 in the database 110 via the server 210. The database 110 may be internal or external to the server 210.

In some configurations, the application 215 may capture one or more images via the camera 120. For example, the application 215 may use the camera 120 to capture an image of an object with a scale marker in contact with the object (e.g., a user holding a scale marker in contact with the user's head). In one example, upon capturing the image, the application 215 may transmit the captured image to the server 210.

In some configurations, the scaling module 115 may obtain the image and may generate a scaled 3D model of the object (e.g., a scaled 3D representation of a user) as describe above and as will be described in further detail below. In one example, the scaling module 115 may transmit scaling information and/or information based on the scaled 3D model of the object to the device 105-a. In some configurations, the application 215 may obtain the scaling information and/or information based on the scaled 3D model of the object and may output an image based on the scaled 3D model of the object to be displayed via the display 125.

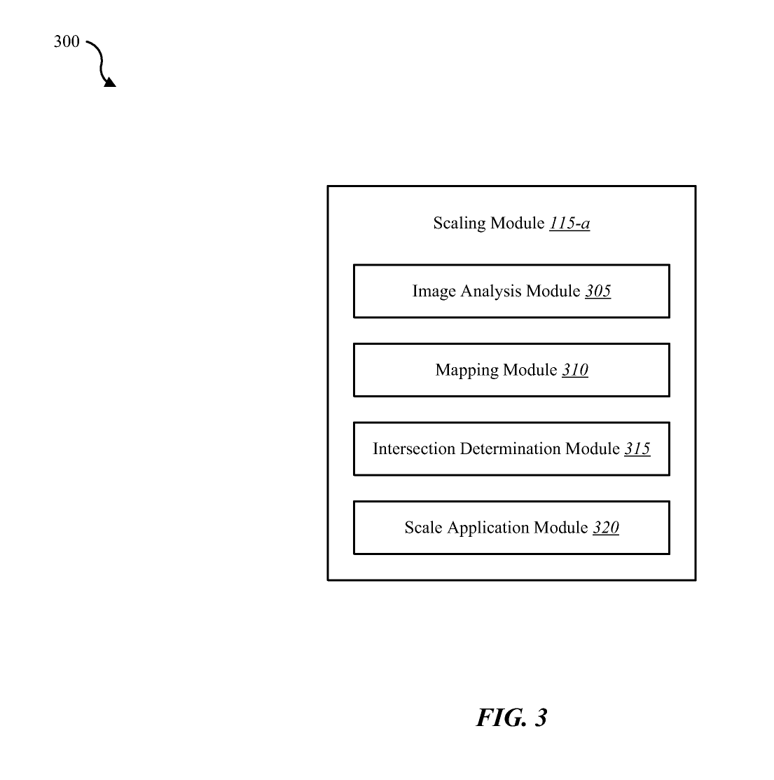

FIG. 3 is a block diagram illustrating one example of a scaling module 115-a. The scaling module 115-a may be one example of the scaling module 115 illustrated in FIG. 1 or 2.

In some configurations, the scaling module 115-a may obtain an image (depicting an object and a scale marker, for example), a 3D model of the object, and a 3D model of the scale marker. In one example, image may depict only a portion of the object and only a portion of the scale marker. As noted previously, the scale marker may have a known size. Thus, the obtained 3D model of the scale marker may have a known size. For instance, the 3D model of the scale marker may be modeled to have the precise dimensions of the predetermined size. As will be described in further detail below, the scaling module 115-a may scale the 3D model of the object based on the known size of the 3D model of the scale marker. In some embodiments, the scaling module 115-a may include an image analysis module 305, a mapping module 310, an intersection determination module 315, and a scale application module 320.

In one embodiment, the image analysis module 305 may analyze one or more objects depicted in an image. For example, the image analysis module 305 may detect the orientation (e.g., relative orientation) of an object, the size (e.g., relative size) of an object, and/or the position (e.g., the relative position) of an object. Additionally or alternatively, the image analysis module 305 may analyze the relationship between two or more objects in an image (the object and the scale marker, for example). For example, the image analysis module 305 may detect the orientation of a first object (e.g., a user's head, the orientation of the user's face, for example) relative to a detected orientation of a second object (e.g., a credit card, the orientation of the face of the credit card, for example). In another example, the image analysis module 305 may detect the position of the first object relative to the detected position of the second object. In yet another example, the image analysis module 305 may detect the size of the first object relative to the detected size of the second object. For instance, in the case that the image depicts a user's face/head and with a credit card touching the forehead of the user, the image analysis module 305 may detect the orientation, size, and/or position of the user's face and/or head, and the orientation, size, and/or position of the credit card (with respect to the orientation, size, and/or position of the user's face and/or head, for example).

In some cases, the image analysis module 305 may identify that an object in the image is a scale marker. In the case that the object in the image is a scale marker, the scaling module 115-a may obtain the 3D model of the scale marker, corresponding to the identified scale marker. For example, if the image analysis module 305 detects that the scale marker is a credit card, then the scaling module 115-a may obtain an appropriately scaled 3D model of a credit card. In a similar manner, the image analysis module 305 may identify that an object in the image is a user. In this case, the scaling module 115-a may obtain a 3D model of the user (e.g., a morphable model of the user). In one example, the image analysis module 305 may identify a scale marker in an image of a user holding the scale marker. In some cases, the image analysis module 305 may identify a scale marker if at least a portion of the scale marker is depicted in the image. Similarly, the image analysis module 305 may identify a user if at least a portion of the user is depicted in the image. For instance, if the image includes at least a portion of the user holding the scale marker in contact with some part of the portion of the user included in the image, then the image analysis module 305 may identify the user and the scale marker and the relative orientation, position, and size of the user and the scale marker.

In one embodiment, the mapping module 310 may map a 3D model of an object and a 3D model of the scale marker into a 3D space based on the image. For example, the mapping module 310 may map the 3D model of the object into the 3D space based on the determined orientation, size, and/or position of the object depicted in the image, and may map the 3D model of the scale marker into the 3D space based on the determined orientation, size, and/or position of the scale marker depicted in the image. For instance, the mapping module 310 may arrange the 3D model of the object and the 3D model of the scale marker in a manner to model the object and the scale marker and the relationship between the two as they are depicted in the image. The mapping module 310 is described in further detail below.

In one embodiment, the intersection determination module 315 may determine a point of intersection between the 3D model of the scale marker and the 3D model of the object. For example, the intersection determination module 315 may determine one or more points of contact between the 3D model of the scale marker and the 3D model of the object (one or more points where the 3D model of scale marker and the 3D model of the object are touching, for example). In some cases, the intersection determination module 315 may adjust the orientation, size, and/or position of the 3D model of the object and/or the 3D model of the scale marker (based on the image, for example) to create at least one point of intersection between the 3D model of the object and the 3D model of the scale marker. For instance, the intersection determination module 315 may fine-tune the mapping of the mapping module 310 to find a point of intersection between the 3D model of the object and the 3D model of the scale marker.

In some cases, the point of intersection may correspond to a range of possible touching values. For instance, the number of points of contact and the distribution of points of contact, and thus the range of the possible touching values, may depend on a variety of factors associated with both the object and the scale marker (rigidity, flexibility, surface firmness, impressionability, etc.). In one example, the intersection determination module 315 may determine and/or recreate the relationship depicted in the photo between the 3D model of the object and the 3D model of the scale marker in the 3D space.

In one embodiment, the scale application module 320 may scale the 3D model of the object based on the known size of the 3D model of the scale marker. For example, the scale application module 320 may directly apply the scale from the 3D model of the scale marker (which has a known size) to the 3D model of the object. For instance, the scale of the 3D model of the scale marker may be directly applied to the 3D model of the object because the 3D model of the object and the 3D model of the scale marker may be mapped into the 3D space based on the image and may be touching. In one example, the scale application module 320 may define the mapped 3D model of the object as scaled according to a common scaling standard as the scaling standard of the 3D model of the scale marker. In one example, the 3D model of the object may be a morphable model that is described in terms of a linear combination of terms. In this example, the linear combination of terms corresponding to the mapped and touching 3D model of the object may be stored as a scaled 3D model of the object (scaled according to the scaling standard of the scaled 3D model of the scale marker, for example).

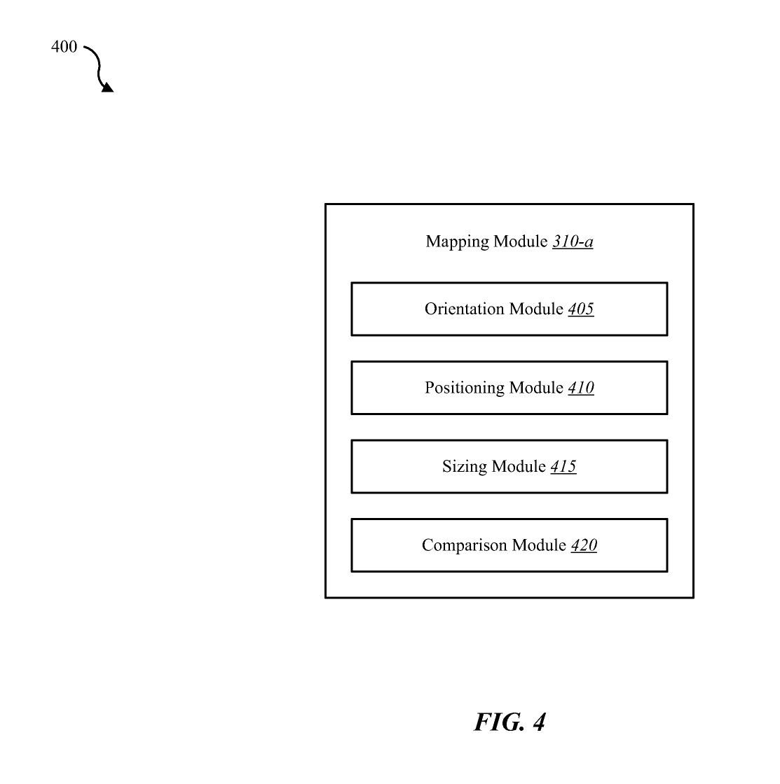

FIG. 4 is a block diagram illustrating one example, of a mapping module 310-a. The mapping module 310-a may be one example of the mapping module 310 illustrated in FIG. 3. In some configurations, the mapping module 310-a may map a 3D model of an object and a 3D model of a scale marker together (based on an image, for example) to generate a combined 3D model that models in a 3D space the object and the scale marker as they where when captured in the image (their relative orientations, positions, and size, for example). In some configurations, the mapping module 310-a may include an orientation module 405, a positioning module 410, a sizing module 415, and a comparison module 420.

In one embodiment, the orientation module 405 may adjust the orientation of a 3D model based on a determined orientation from an image. For example, the orientation module 405 may adjust the orientation of a 3D model of the object in a 3D space based on the determined orientation of the object in the image (as determined by the image analysis module 305, for example). In another example, the orientation module 405 may adjust the orientation of a 3D model of the scale marker in the 3D space based on the determined orientation of the scale marker in the image (as determined by the image analysis module 305, for example). In some configurations, the orientation module 405 may adjust the orientation of the 3D model of the object and/or the orientation of the 3D model of the scale marker in relation to each other based on the relative orientations of the object and the scale marker determined from the image. In some cases, the orientation module 405 may adjust the orientation of the 3D model of the object and/or the orientation of the 3D model of the scale marker in the same 3D space based on individual orientations of the object and the scale marker and/or the relationship between the relative orientations of the object and the scale marker. In some cases, the determined orientation of a user corresponds to the determined orientation of the user's face (an x, y, z, coordinate value, for example).

In one embodiment, the positioning module 410 may adjust the position of a 3D model based on a determined position from an image. For example, the positioning module 410 may adjust the position of a 3D model of an object in a 3D space based on the determined position of the object in the image (as determined by the image analysis module 305, for example). In another example, the positioning module 410 may adjust the position of a 3D model of a scale marker in the 3D space based on the determined position of the scale marker in the image (as determined by the image analysis module 305, for example). In some configurations, the positioning module 410 may adjust the position of the 3D model of the object and/or the position of the 3D model of the scale marker in relation to each other based on the relative positions of the object and the scale marker determined from the image. In some cases, the positioning module 410 may adjust the position of the 3D model of the object and/or the position of the 3D model of the scale marker in the same 3D space based on individual positions of the object and the scale marker and/or the relationship between the relative positions of the object and the scale marker.

In one embodiment, the sizing module 415 may adjust the size of a 3D model based on a determined size from an image. For example, the sizing module 415 may adjust the size of a 3D model of an object in a 3D space based on the determined size of the object in the image (as determined by the image analysis module 305, for example). In another example, the sizing module 415 may adjust the size of a 3D model of a scale marker in the 3D space based on the determined size of the scale marker in the image (as determined by the image analysis module 305, for example). In some configurations, the sizing module 415 may adjust the size of the 3D model of the object and/or the size of the 3D model of the scale marker in relation to each other based on the relative sizes of the object and the scale marker determined from the image. In some cases, the sizing module 415 may adjust the size of the 3D model of the object and/or the size of the 3D model of the scale marker in the same 3D space based on individual size of the object and the scale marker and/or the relationship between the relative size of the object and the scale marker.

In one embodiment, the comparison module 420 may compare one or more characteristics (e.g., orientation, position, size, etc.) of a 3D model of an object with one or more characteristics of a 3D model of a scale marker based on the image. Additionally or alternatively, the comparison module 420 may compare one or more characteristics of the object with one or more characteristics of the scale marker. For example (in the case that the image includes at least a potion of a user and at least a portion of a scale marker, for example), the comparison module 420 may compare the size of the 3D model of the user with the size of the 3D model of the scale marker based on the relationship between the size of the portion of the user in the image and the size of the portion of the scale marker in the same image. In some cases, the mapping module 310-a may adjust (via the orientation module 405, positioning module 410, and/or sizing module 415, for example) the orientation, position, and/or size of the 3D model of the user and/or the 3D model of the scale marker based on a comparison result of the comparison module 420.

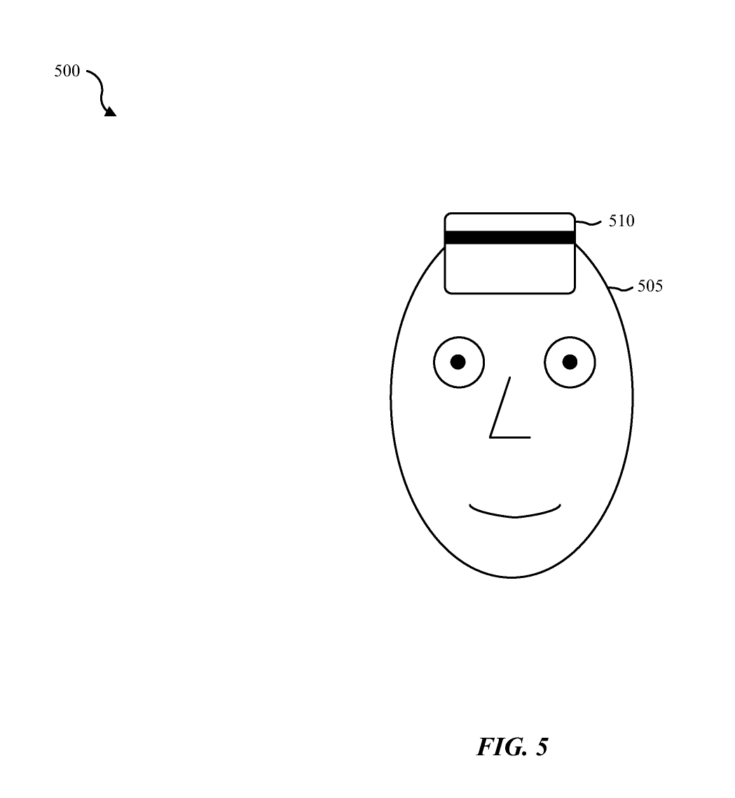

FIG. 5 is a diagram 500 illustrating one example of an object and a scale marker that may be captured in an image for use in the systems and methods described herein. As described above, the user 505 (e.g., object) may hold an object of known size (e.g., scale marker) in contact with a portion of the user (touching, for example). In one embodiment, the object of known size may be a credit card 510. For example, as depicted, the user 505 may hold a credit card 510 against his/her forehead. Alternatively, the user 510 may hold the credit card 510 against another portion of the user's body such as the user's hand or foot. It is understood that the scale marker may be any object of known or ascertainable size. For example, the user may hold a different object of known size such as currency or a ruler. Alternatively, the user may use an object whose dimensions can be ascertained, such as a mobile device (e.g., smartphone, tablet), the device (e.g., mobile device) that is capturing the image, and the like.

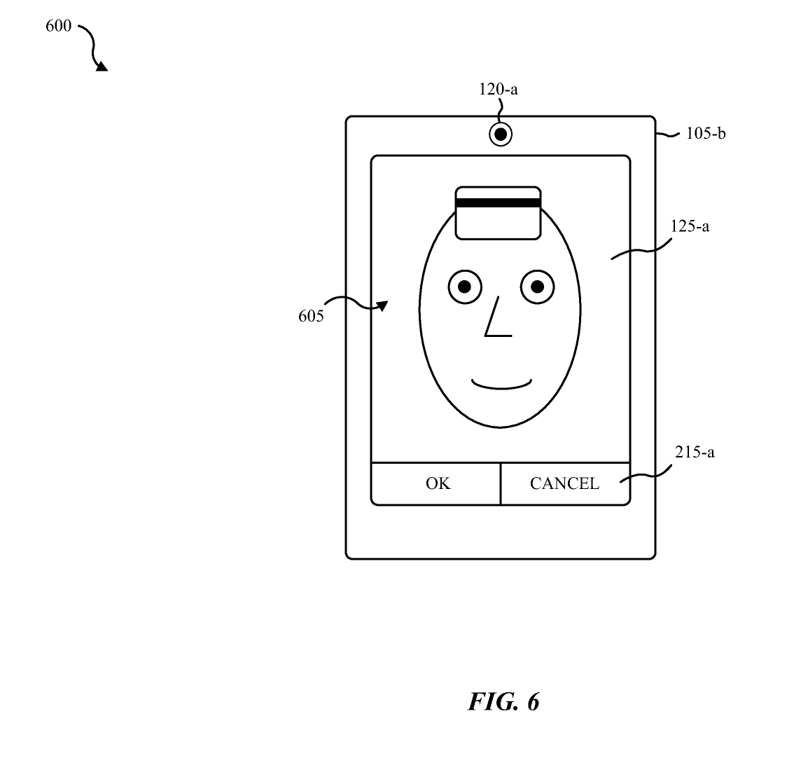

FIG. 6 is a diagram 600 illustrating an example of a device 105-b for capturing an image 605 of the user 505 holding the credit card 510. The device 105-b may be one example of the devices 105 illustrated in FIG. 1 or 2. As depicted, the device 105-b may include a camera 120-a, a display 125-a, and an application 215-a. The camera 120-a, display 125-a, and application 215-a may each be an example of the respective camera 120, display 125, and application 215 illustrated in FIG. 1 or 2.

In one embodiment, the user 505 may operate the device 105-b. For example, the application 215-a may allow the user 505 to interact with and/or operate the device 105-b. In one example, the user 505 may hold a credit card 510 to his or her forehead. In one embodiment, the application 215-a may allow the user 505 to capture an image 605 of the user 505 holding the credit card 510 to his or her forehead. For example, the application 215-a may display the image 605 on the display 125. In some cases, the application 215-a may permit the user 505 to accept or decline the image 605. In one example, the device 105-b is the scale marker that is in contact with the face and the image 605 is captured using a mirror. For instance the camera may capture the reflection of the user and the device 105-b in the mirror to obtain the image of the user with the object of known size.

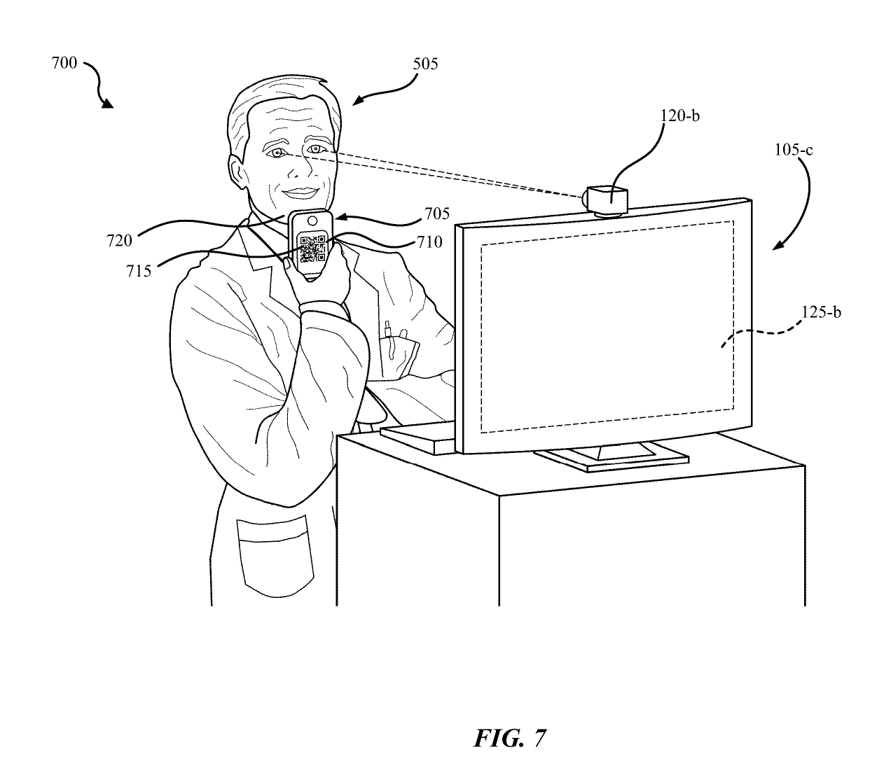

FIG. 7 illustrates an example arrangement 700 for capturing an image 605 that includes a depiction of a scale marker and a depiction of an object. In this example, the scaling marker may be a mobile device 705. In one embodiment, the user 505 may hold a mobile device 705 in contact with the user's face (e.g., against the user's chin 720).

In one example, the mobile device 705 may include a display 710 that is displaying information (e.g., a Quick Response (QR) code 715) that identifies the mobile device 705 so that the known size of the mobile device 705 may be determined or otherwise ascertained. For example, the information may identify the make and/or model of the mobile device 705 and/or the actual dimensions of the device. In one example, the user 505 may access a website that determines the type of device (based on browser session information, for example) and provides a device specific QR code 715 that identifies the device so that a known size for the device may be determined. In some cases, the displayed QR code may be specifically formatted for the display 710 (e.g., screen and/or pixel configuration) of the mobile device 705 so that the QR code 715 is displayed at a known size. In this scenario, the QR code 715 may itself (additionally or alternatively) be a scaling marker that may be used in accordance with the systems and methods described herein.

In one embodiment, the display 710 may be facing toward a camera 120-b so that the information being displayed by the display 710 may be captured in the image. The camera 120-b may be in electronic communication with a computing device 105-c that includes a processor. The computing device 105-c may be one example of the device 105 illustrated in FIG. 1, 2, or 6. In some cases, the camera 120-b may be an integral part of the computing device 105-c. In other cases, the camera 120-b may be mounted separate from the computing device 105-c. For example, as shown in FIG. 7, the camera 120-b may be mounted to the computing device 105-c in the form of, for example, a web cam attached to a monitor of the computing device 105-c. The camera 120-b may be any camera in communication with a computing device 105-c, such as a mobile phone, a tablet computer, a PDA, a laptop, a desktop computer, and the like.

In one example, the camera 120-b may collect an image that includes a depiction of the user 505 and a depiction of the mobile device 705 (including the information (e.g., QR code 715) that is being displayed by the display 710 of the mobile device 705, for example). In the case that the type of the mobile device 705 is not inherently known, the computing device 105-c may determine the known size of the mobile device 705 based on the identifying information (the QR code 715, for example) shown on the display 715. For instance, the computing device 105-c and/or the scaling module 115 may access the Internet and/or a database and may use the identifying information to determine the known size of the mobile device 705.

In some cases, the computing device 105-c and the mobile device 705 may collaborate together to determine the distance between the two devices. In one example, the user holds a second mobile device (an iPad, for example) (shown as the computing device 105-c in this example) with the screen 125-b and front facing camera 120-b looking back at the user's face in one hand and the first mobile device 705 (an iPhone, for example) in contact with the user's face with the other hand. The user 505 may hold the first mobile device 705 so that the display 710 (e.g., screen) of the mobile device 705 and the front facing camera on the mobile device 705 are looking back at the screen 125-b and camera 120-b of the second mobile device. In some configurations, this setup may allow the distance between the second mobile device and the first mobile device 705 to be determined. In some cases, the determination of this distance may be used to scale the depicted image. In some cases, this may be beneficial in the scaling of the 3D model of the object.

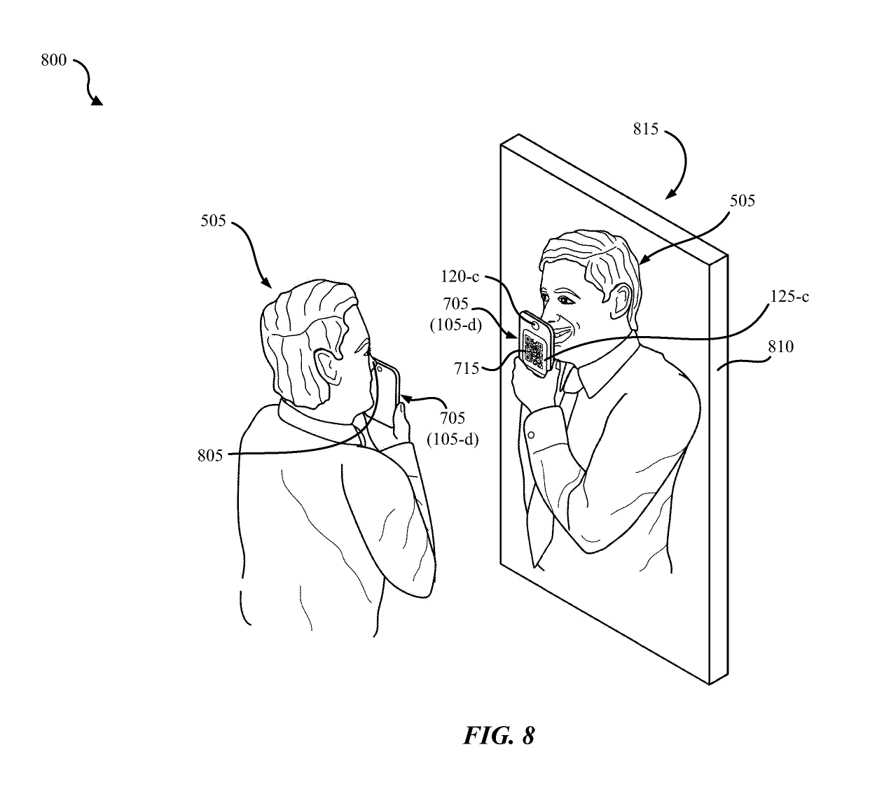

FIG. 8 illustrates another example arrangement 800 for capturing an image 605 that includes a depiction of a scale marker and a depiction of an object. In this embodiment, the mobile device 705 is both the scale marker and the device 105-d that is capturing the image 605. For example, the mobile device 705 may be an example of the device 105 illustrated in FIG. 1, 2, 6, or 7. In this embodiment, a reflective surface (e.g., a mirror 810) or like device, may be used. In one example, the user 505 may hold the mobile device 705 against the nose 805 of the user 705. The user 505 may direct the display 125-c of the mobile device 705 and the camera 120-c to face toward the mirror 810 so that the display 125-c and a QR code 715 displayed by the display 125-c are visible in the mirror 810. In some cases, the user may face the mirror 810 so that the user 505 is directly looking at the mirror 810 (so that both eyes and their associated pupils are visible in the mirror 810, for example).

FIG. 7 shows a reflection 815 of the user 505 and the mobile device 705 within the mirror 810. In some cases, the reflection 815 may includes at least a portion of the user 505 (including the user's face and/or eyes, for example), at least a portion of the mobile device 705, the camera 120-c, the display 125-c, and/or the device specific QR code 715 being displayed by the display 125-c. In at least some arrangements, the display 125-c shows a window frame that the user can see in the reflection 815 to make sure that the mobile device 705 and the user's face and/or eyes are within the picture being taken by handheld mobile device 705. The user 505 may then capture a picture (e.g., image) of the reflection 815.

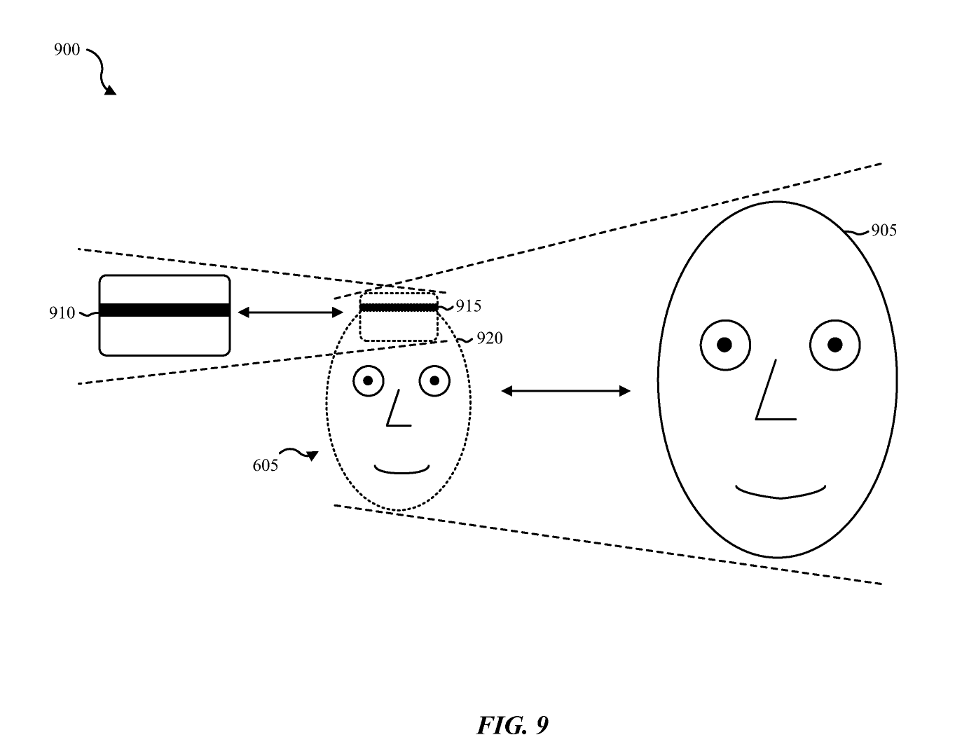

FIG. 9 is a diagram illustrating one example of an operation 900 of the scaling module 115 to map a 3D model of a user 905 and a 3D model of a scale marker into the same 3D space. In one example, the scaling module 115 may obtain an image 605 that includes a depiction of the user 920 and a depiction of the scale marker (a credit card 915, in this example). Additionally, the scaling module 115 may obtain a 3D model of the user 905 and a 3D model of the credit card 910. Although the 3D model of the credit card 910 may have a known size based on a known scaling standard, the 3D model of the user 905 may have an arbitrary size.

In one example, the scaling module 115 may map the 3D model of the user 905 and the 3D model of the credit card 910 into the same 3D space based on the depiction of the user 920 and the depiction of the credit card 915. For example, the scaling module 115 may compare the relationship between the orientation, position, and/or size of the 3D model of the user 905 and the orientation, position, and/or size of the 3D model of the credit card 910 with the relationship between the orientation, position, and/or size of the depiction of the user 920 and the orientation, position, and/or size of the depiction of the credit card 915. In some cases, the scaling module 115 may adjust the orientation, position, and/or size of the 3D model of the user 905 and/or orientation, position, and/or size of the 3D model of the credit card 910 based on the results of the comparison. For example, mapping the 3D model of the user 905 and the 3D model of the credit card 910 to the same space may include adjusting the size, position, and orientation of the 3D model of the user 905 so that it corresponds to the size, position, and orientation of the depiction of the user 920 and may include adjusting the size, position, and orientation of the 3D model of the credit card 910 so that it corresponds to the size, position, and/or orientation of the depiction of the credit card 915. For instance, mapping the 3D model of the user 905 and the 3D model of the credit card 910 into the same 3D space includes adjusting the orientation, position, and/or size of the 3D model of the user 905 and/or the 3D model of the credit card 910 so that the relationship between the orientation, position, and size of the 3D model of the scale marker 910 in the 3D space and the orientation, position, and size of the 3D model of the user 905 in the 3D space is the same as the relationship between the orientation, position, and size of the depiction of the scale marker 915 in the image 605 and the orientation, position, and size of the depiction of the user 920 in the image.

In another example, the position and size of the 3D model of the scale marker 910 may be adjusted according to the position and size of the scale marker 915 in the image 605. Similarly, the position and size of the 3D model of the user 905 may be adjusted according to the position and size of the depiction of the user 920 in the image 605. For example, the relationship between the position and size of the 3D model of the scale marker 910 and the 3D model of the user 905 may be the same as the relationship between the position and size of the depiction of the scale marker 915 and the depiction of the user 920 in the image 605.

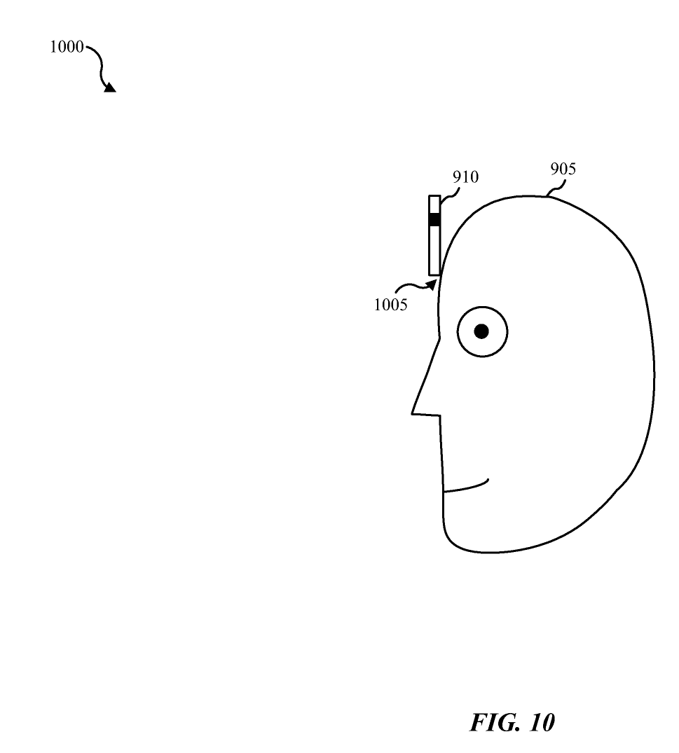

FIG. 10 is a diagram illustrating one example of an operation 1000 of the scaling module 115 to determine a point of intersection between the 3D model of the user 905 and the 3D model of the scale marker 910. In one example, the scaling module 115 may determine a point of intersection 1005 between a point on the 3D model of the scale marker 910 and a point on the 3D model of a portion of the user 905. In some cases, the scaling module 115 may position the 3D model of a portion of the user 905 so that at least one point on the 3D model of the user 905 intersects at least one point on the 3D model of the scale marker 910. For instance, the scaling module 115 may adjust the position of the 3D model of the user 905 and/or the 3D model of the scale marker 910 so that 3D model of the scale marker 910 is touching the 3D model of the user 905 (by bringing the models closer together or further apart to create a natural touching between them, for example). In one example, upon mapping the 3D model of the user 905 and the 3D model of the scale marker 910 to the same 3D space and determining the point intersection between them, the scaling module 115 may scale the 3D model of the user 905 based on the known scale of the 3D model of the scale marker 910. For example, the known scale of the 3D model of the scale marker 910 may be applied to the 3D model of the user 905 based on the adjustments to the mapped 3D models and the determined point of intersection (e.g., touching). In one example, applying the known scaling to the 3D model of the user 905 results in a scaled 3D model of the user.

In one example, the scaled 3D model of the user may be used to render images that may be displayed (to the user, for example) on a display (display 125, for example). For instance, the scaled 3D model of the user and a scaled 3D model of a product (e.g., a scaled pair of glasses, scaled based on the same scaling standard, for example) may be used to render images for a properly scaled virtual try-on. In one example, a properly scaled virtual try-on may facilitate a realistic virtual try-on shopping experience. For instance, a properly scaled user try-on may allow a pair of glasses to be scaled properly with respect to the user's face/head. In some cases, this may enable a user to shop for glasses and to see how the user looks in the glasses (via the properly scaled virtual try-on) simultaneously.

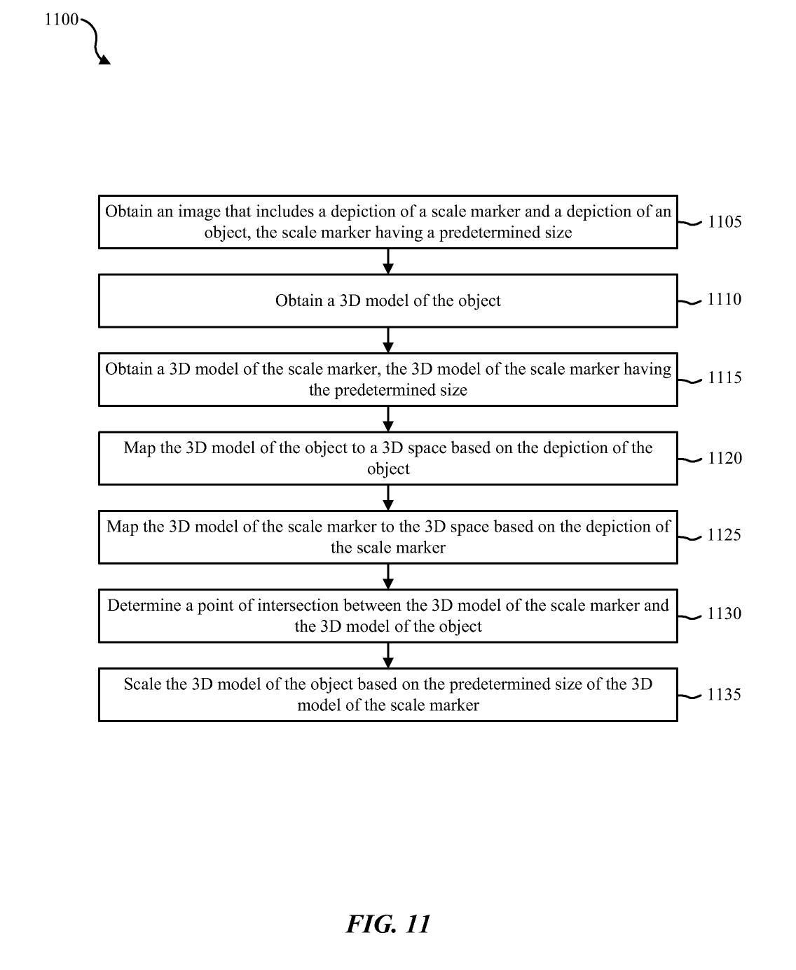

FIG. 11 is a flow diagram illustrating one example of a method 1100 to scale a 3D model. In some configurations, the method 1100 may be implemented by the scaling module 115 illustrated in FIG. 1, 2, or 3. At block 1105, an image that includes a depiction of a scale marker and a depiction of an object may be obtained. The scale marker may have a predetermined size. It may be noted, that in some cases, the scale marker may cover up a portion of the object. In at least some of these cases, the depiction of the object may be a portion of the object because the scale marker is covering another portion of the object (because they are touching, for example). In one example, the image may depict a user holding an object of know size (e.g., a credit card) in contact with the user's forehead.

At block 1110, a 3D model of the object may be obtained. At block 1115, a 3D model of the scale marker may be obtained. The 3D model of the scale marker may have the predetermined size.

At block 1120, the 3D model of the object may be mapped to a 3D space based on the depiction of the object. For example, the 3D model of the object may be mapped to the 3D space based on the relationship between the depiction of the object and the depiction of the scale marker.

At block 1125, the 3D model of the scale marker may be mapped to the 3D space based on the depiction of the scale marker. For example, the 3D model of the scale marker may be mapped to the 3D space based on the relationship between the depiction of the object and the depiction of the scale marker.

At block 1130, a point of intersection between the 3D model of the scale marker and the 3D model of the object may be determined. For example, the point of intersection may correspond to the point of contact between the 3D model of the scale marker and the 3D model of the object (because they are touching, for example).

At block 1135, the 3D model of the object may be scaled based on the predetermined size of the 3D model of the scale marker. For example, the scaling standard for the predetermined size of the 3D model of the scale marker may be directly to the 3D model of the object based on the mapping to the 3D space and the determined point of intersection.

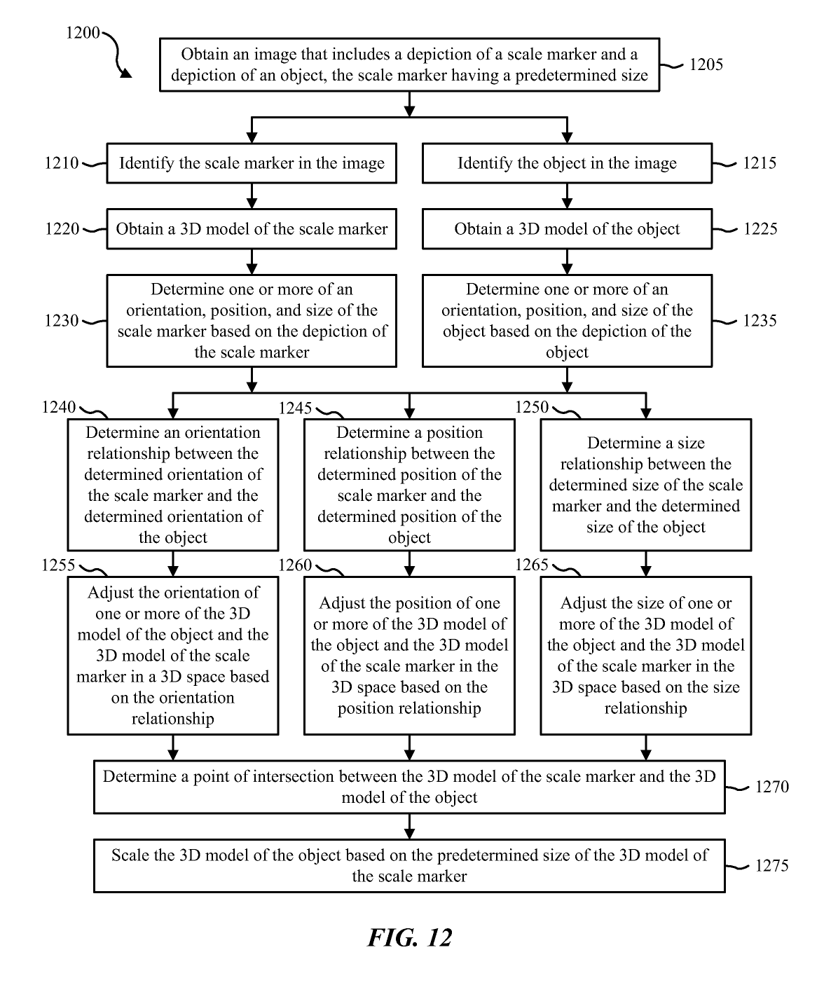

FIG. 12 is a flow diagram illustrating another example of a method 1200 to scale a 3D model. In some configurations, the method 1200 may be implemented by the scaling module 115 illustrated in FIG. 1, 2, or 3.

At block 1205, an image that includes a depiction of a scale marker and a depiction of an object may be obtained. The scale marker may have a predetermined size. For example, the image may be obtained from a camera on a device.

At block 1210, the scale marker may be indentified in the image. For example, the scale marker may be identified by the depiction of the scale marker included in the image. At block 1215, the object may be indentified in the image. For example, the object may be identified by the depiction of the object included in the image.

At block 1220, a 3D model of the scale marker may be obtained. For example, the 3D model of the scale marker may be retrieved from a storage device. In some cases, the 3D model of the scale marker may be modeled according to the predetermined sized. For instance, the 3D model of the scale marker may have the predetermined size.

At block 1225, a 3D model of the object may be obtained. For example, the 3D model of the object may be retrieved from a storage device. In some cases, the 3D model of the object may be a morphable model. For instance, the 3D model of the object may be a morphable model of a user's face and/or head.

At block 1230, one or more of an orientation, position, and size of the scale marker may be determined based on the depiction of the scale marker. For example, the orientation may be determined based on a surface of the scale marker (the orientation of a vector that is normal to the surface, for example). In some cases, the position and/or the size of the scale marker may be relative to the position and/or size of the object.

At block 1235, one or more of an orientation, position, and size of the object may be determined based on the depiction of the object. For example, the orientation may be determined based on a surface of the object (the orientation of a vector that is normal to the surface, for example). In another example, the orientation may be determined by determining based on the direction that a face is pointing (using a face tracking algorithm, for example). In some cases, the position and/or the size of the object may be relative to the position and/or size of the scale marker.

At block 1240, an orientation relationship between the determined orientation of the scale marker and the determined orientation of the object may be determined. For example, the orientation relationship may be based on a difference in orientation between the determined orientation of the scale marker and the determined orientation of the object (with respect to the same coordinate system, for example).

At block 1245, a position relationship between the determined position of the scale marker and the determined position of the object may be determined. For example, the position relationship may be based on the determined position of the scale marker relative to the determined position of the object (the difference between the two, for example).

At block 1250, a size relationship between the determined size of the scale marker and the determined size of the object may be determined. For example, the size relationship may be based on the determined size of the scale marker relative to the determined size of the object (the difference between the two, for example).

At block 1255, the orientation of one or more of the 3D model of the object and the 3D model of the scale marker may be adjusted based on the determined orientation relationship. For example, the orientation of the 3D model of the object and/or the orientation of the 3D model of the scale marker may be adjusted so that an orientation relationship between the two 3D models is the same as the determined orientation relationship. In some cases, the adjusting of the orientation of the 3D model of the object and/or the orientation of the 3D model of the scale marker may result in a combined 3D model in the 3D space that recreates the relationship between the object and the scale marker as they were when they were captured in the image.

At block 1260, the position of one or more of the 3D model of the object and the 3D model of the scale marker may be adjusted based on the determined position relationship. For example, the position of the 3D model of the object and/or the position of the 3D model of the scale marker may be adjusted so that a position relationship between the two 3D models is the same as the determined position relationship. In some cases, the adjusting of the position of the 3D model of the object and/or the position of the 3D model of the scale marker may result in a combined 3D model in the 3D space that recreates the relationship between the object and the scale marker as they were when they were captured in the image.

At block 1265, the size of one or more of the 3D model of the object and the 3D model of the scale marker may be adjusted based on the determined size relationship. For example, the size of the 3D model of the object and/or the size of the 3D model of the scale marker may be adjusted so that a size relationship between the two 3D models is the same as the determined size relationship. In some cases, the adjusting of the size of the 3D model of the object and/or the size of the 3D model of the scale marker may result in a combined 3D model in the 3D space that recreates the relationship between the object and the scale marker as they were when they were captured in the image.

At block 1270, a point of intersection may be determined between the 3D model of the scale marker and the 3D model of the object. For example, the 3D model of the object and the 3D model of the scale marker may be repositioned (moved closer together or further apart, for example) so that the 3D model of the scale marker and the 3D model of the object are touching (have at least one point of intersection between them, for example). In some cases, upon adjusting the 3D models based on the image, the 3D models may be touching in the 3D space (without repositioning either of the 3D models. In one example, a point of intersection corresponds to a point at which a point on the surface of the 3D model of the object and a point on the surface of the 3D model of the scale marker would contact each other (or touch, for example). At block 1275, the 3D model of the object may be scaled based on the predetermined size (e.g., known size) of the 3D model of the scale marker.

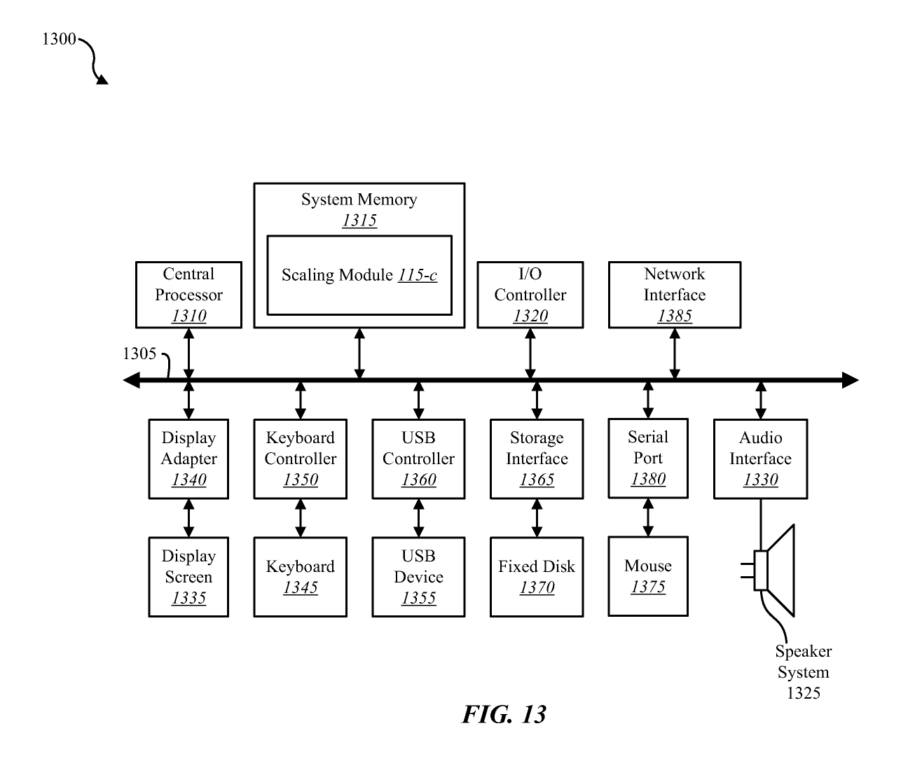

FIG. 13 depicts a block diagram of a computer system 1300 suitable for implementing the present systems and methods. For example, the computer system 1300 may be suitable for implementing the device 105 illustrated in FIG. 1, 2, or 6 and/or the server 210 illustrated in FIG. 2. Computer system 1300 includes a bus 1305 which interconnects major subsystems of computer system 1300, such as a central processor 1310, a system memory 1315 (typically RAM, but which may also include ROM, flash RAM, or the like), an input/output controller 1320, an external audio device, such as a speaker system 1325 via an audio output interface 1330, an external device, such as a display screen 1335 via display adapter 1340, a keyboard 1345 (interfaced with a keyboard controller 1350) (or other input device), multiple universal serial bus (USB) devices 1355 (interfaced with a USB controller 1360), and a storage interface 1365. Also included are a mouse 1375 (or other point-and-click device) interfaced through a serial port 1380 and a network interface 1385 (coupled directly to bus 1305).

Bus 1305 allows data communication between central processor 1310 and system memory 1315, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, the scaling module 135 to implement the present systems and methods may be stored within the system memory 1315. Applications (e.g., application 215) resident with computer system 1300 are generally stored on and accessed via a non-transitory computer readable medium, such as a hard disk drive (e.g., fixed disk 1370) or other storage medium. Additionally, applications can be in the form of electronic signals modulated in accordance with the application and data communication technology when accessed via interface 1385.

Storage interface 1365, as with the other storage interfaces of computer system 1300, can connect to a standard computer readable medium for storage and/or retrieval of information, such as a fixed disk drive 1344. Fixed disk drive 1344 may be a part of computer system 1300 or may be separate and accessed through other interface systems. Network interface 1385 may provide a direct connection to a remote server via a direct network link to the Internet via a POP (point of presence). Network interface 1385 may provide such connection using wireless techniques, including digital cellular telephone connection, Cellular Digital Packet Data (CDPD) connection, digital satellite data connection, or the like.

Many other devices or subsystems (not shown) may be connected in a similar manner (e.g., document scanners, digital cameras, and so on). Conversely, all of the devices shown in FIG. 13 need not be present to practice the present systems and methods. The devices and subsystems can be interconnected in different ways from that shown in FIG. 13. The operation of a computer system such as that shown in FIG. 13 is readily known in the art and is not discussed in detail in this application. Code to implement the present disclosure can be stored in a non-transitory computer-readable medium such as one or more of system memory 1315 or fixed disk 1370. The operating system provided on computer system 1300 may be iOS®, MS-DOS®, MS-WINDOWS®, OS/2®, UNIX®, Linux®, or another known operating system.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. A computer-implemented method for scaling a three-dimensional (3D) model, the method comprising:
obtaining an image that includes a depiction of a scale marker and a depiction of an object, the scale marker having a predetermined size;
mapping a 3D model of the object to a 3D space based at least in part on the depiction of the object;
mapping a 3D model of the scale marker to the 3D space based at least in part on the depiction of the scale marker, the 3D model of the scale marker having the predetermined size; and
scaling the 3D model of the object based at least in part on the predetermined size of the 3D model of the scale marker.

2. The method of claim 1, further comprising:
determining a point of intersection between the 3D model of the scale marker and the 3D model of the object.

3. The method of claim 2, further comprising:
adjusting one or more of the 3D model of the object and the 3D model of the scale marker in the 3D space to obtain the point of intersection.

4. The method of claim 1, further comprising:
determining a first relationship based at least in part on the depiction of the object and the depiction of the scale marker, wherein the first relationship is between the object and the scale marker.

5. The method of claim 4, wherein mapping the 3D model of the object to the 3D space comprises:
adjusting the 3D model of the object to obtain a second relationship that is the same as the first relationship, wherein the second relationship is between the 3D model of the object and the 3D model of the scale marker.

6. The method of claim 4, wherein mapping the 3D model of the scale marker to the 3D space comprises:
adjusting the 3D model of the scale marker to obtain a second relationship that is the same as the first relationship, wherein the second relationship is between the 3D model of the object and the 3D model of the scale marker.

7. The method of claim 4, wherein the first relationship comprises an orientation relationship between an orientation of the object and an orientation of the scale marker.

8. The method of claim 4, wherein the first relationship comprises a position relationship between a position of the object and a position of the scale marker.

9. The method of claim 4, wherein the first relationship comprises a size relationship between a size of the object and a size of the scale marker.

10. The method of claim 1, wherein the 3D model of the object comprises a morphable model.

11. A computing device configured to scale a three-dimensional (3D) model, comprising:
a processor;
memory in electronic communication with the processor;
instructions stored in the memory, the instructions being executable by the processor to:
obtain an image that includes a depiction of a scale marker and a depiction of an object, the scale marker having a predetermined size;
map a 3D model of the object to a 3D space based at least in part on the depiction of the object;
map a 3D model of the scale marker to the 3D space based at least in part on the depiction of the scale marker, the 3D model of the scale marker having the predetermined size; and
scale the 3D model of the object based at least in part on the predetermined size of the 3D model of the scale marker.

12. The computer device of claim 11, wherein the instructions are further executable by the processor to:
determine a point of intersection between the 3D model of the scale marker and the 3D model of the object.

13. The computing device of claim 11, wherein the instructions are further executable by the processor to:
adjust one or more of the 3D model of the object and the 3D model of the scale marker in the 3D space to obtain the point of intersection.

14. The computing device of claim 11, wherein the instructions are further executable by the processor to:
determine a first relationship based at least in part on the depiction of the object and the depiction of the scale marker, wherein the first relationship is between the object and the scale marker.

15. The computing device of claim 14, wherein the instructions to map the 3D model of the object to the 3D space are further executable by the processor to:
adjust the 3D model of the object to obtain a second relationship that is the same as the first relationship, wherein the second relationship is between the 3D model of the object and the 3D model of the scale marker.

16. The computing device of claim 14, wherein the instructions to map the 3D model of the scale marker to the 3D space are further executable by the processor to:
adjust the 3D model of the scale marker to obtain a second relationship that is the same as the first relationship, wherein the second relationship is between the 3D model of the object and the 3D model of the scale marker.

17. The computing device of claim 14, wherein the first relationship comprises an orientation relationship between an orientation of the object and an orientation of the scale marker.

18. The computing device of claim 14, wherein the first relationship comprises a position relationship between a position of the object and a position of the scale marker.

19. The computing device of claim 14, wherein the first relationship comprises a size relationship between a size of the object and a size of the scale marker.

20. The computing device of claim 11, wherein the 3D model of the object comprises a morphable model.

21. A computer-program product for scaling a three-dimensional (3D) model, the computer-program product comprising a non-transitory computer-readable medium storing instructions thereon, the instructions being executable by a processor to:
obtain an image that includes a depiction of a scale marker and a depiction of an object, the scale marker having a predetermined size;
map a 3D model of the object to a 3D space based at least in part on the depiction of the object;
map a 3D model of the scale marker to the 3D space based at least in part on the depiction of the scale marker, the 3D model of the scale marker having the predetermined size; and
scale the 3D model of the object based at least in part on the predetermined size of the 3D model of the scale marker.

22. The computer-program product of claim 19, wherein the instructions are further executable by the processor to:
determine a point of intersection between the 3D model of the scale marker and the 3D model of the object.

23. The computer-program product of claim 21, wherein the instructions are further executable by the processor to:
adjust one or more of the 3D model of the object and the 3D model of the scale marker in the 3D space to obtain the point of intersection.
